(19) United States
(12) Patent Application Publication
(10) Pub. No.: US 2019/0156226 A1
(43) Pub. Date: May 23, 2019

(54) EQUIPMENT MAINTENANCE PREDICTION SYSTEM AND OPERATION METHOD THEREOF

(71) Applicant: INSTITUTE FOR INFORMATION INDUSTRY, Taipei (TW)

(72) Inventors: YEN-I OUYANG, Kaohsiung (TW); HUNG-MING CHEN, Taichung (TW); SHIH-YING CHEN, Taichung (TW); BING-YU WU, Taichung (TW); ZHENG-HONG LI, New Taipei (TW); YUE-LIN JIANG, Taoyuan (TW)

(21) Appl. No.: 15/868,677

(22) Filed: Jan. 11, 2018

(30) Foreign Application Priority Data
Nov. 21, 2017 (TW) 106140400

(51) Int. Cl. G06N 5/04

(52) U.S. Cl. CPC G06N 5/045

(57) ABSTRACT

An equipment maintenance prediction system and an operation method for the equipment maintenance prediction system are provided. The operation method includes steps of: configuring the processor to configure the factor decision module to select one of a plurality of parameter types as a decision parameter type according to a key parameter type, wherein the decision parameter type and the key parameter type are most correlative; configuring the processor to configure the prediction module to generate a prediction model according to a part of a plurality of historical sensing values of the decision parameter type and formulate a maintenance alerting condition according to a part of a plurality of historical sensing values of the key parameter type; and configuring the processor to configure the maintenance alerting module to monitor and alert according to the maintenance alerting condition.

### FIELD OF THE INVENTION

The present invention relates to an equipment maintenance prediction system and an operation method thereof, and more particularly to an equipment maintenance prediction system and operation method thereof using a two-layer prediction model for prediction.

### BACKGROUND OF THE INVENTION

The conventional equipment maintenance method is based on regular maintenance or fault maintenance. Thus, not only the equipment status cannot be accurately determined but also the equipment damage may be damaged due to the fault is not solved immediately. Therefore, the conventional equipment maintenance methods are not only lack of automation but also have poor efficiency. In addition, the conventional equipment maintenance method generally uses a signal parameter threshold or a signal parameter of statistical results for maintenance. However, the equipment may affect its operating status due to various factors. Therefore, using only a single parameter as a condition to determine whether the equipment needs to be maintained may not be able to accurately predict the status of equipment and also cannot effectively extend the operational life of equipment.

### SUMMARY OF THE INVENTION

In order to solve the above problems, the present invention provides an embodiment of an operation method for an equipment maintenance prediction system. The equipment maintenance prediction system is applied to an equipment and includes a processor, a factor decision module, a prediction module and a maintenance alerting module. The processor is electrically connected to the factor decision module, the prediction module and the maintenance alerting module. The operation method includes steps of: configuring the processor to configure the factor decision module to select one of a plurality of parameter types as a decision parameter type according to a key parameter type, wherein the decision parameter type and the key parameter type are most correlative; configuring the processor to configure the prediction module to generate a prediction model according to a part of a plurality of historical sensing values of the decision parameter type and formulate a maintenance alerting condition according to a part of a plurality of historical sensing values of the key parameter type; and configuring the processor to configure the maintenance alerting module to monitor and alert according to the maintenance alerting condition.

The present invention further provides an embodiment of equipment maintenance prediction system applied to an equipment. The equipment maintenance prediction system includes a processor, an interface module, a factor decision module, a prediction module, a maintenance alerting module and a database. The interface module is electrically connected to the processor and configured to output selection information, wherein the selection information includes a key parameter type and a plurality of parameter types. The factor decision module is electrically connected to the processor and configured to select one of the parameter types as a decision parameter type according to the key parameter type, wherein the decision parameter type and the key parameter type are most correlative. The prediction module is electrically connected to the processor and configured to generate a prediction model according to a part of a plurality of historical sensing values of the decision parameter type and formulate a maintenance alerting condition according to a part of a plurality of historical sensing values of the key parameter type. The maintenance alerting module is electrically connected to the processor and configured to monitor and alert according to the maintenance alerting condition and a plurality of sensing values generated when the equipment operates. The database is electrically connected to the processor and configured to store the historical sensing values of the decision parameter type, the historical sensing values of the key parameter type, the prediction model, the maintenance alerting condition and the sensing values.

In summary, according to the equipment maintenance prediction system and the equipment maintenance prediction method applied to the equipment maintenance prediction system of the present invention, since the decision parameter type having a better correlation with the key parameter type is first selected, the prediction can be performed by the parameter types other than the key parameter type in the case of without additional sensing elements. In addition, compared to the prediction method employing a single key parameter type, the present invention can improve the accuracy of prediction of equipment life more effectively by establishing the prediction model based on the decision parameter type with relatively high correlation. Further, the sensing values and maintenance information generated during the operation of the equipment are continuously recorded in the database, therefore, with the increase of historical sensing values and reference information, each updated prediction model can predict the trend of the sensing values of the key parameter type more effectively and accurately, the system users can perform maintenance more accurately, and he life of the equipment is improved effectively.

### BRIEF DESCRIPTION OF THE DRAWING

The present invention will become more readily apparent to those ordinarily skilled in the art after reviewing the following detailed description and accompanying drawings, in which:

FIG. 1 is a schematic view of an equipment maintenance prediction system according to an embodiment of the present invention;

FIG. 2A is a flow chat of an equipment maintenance prediction method applied to the equipment maintenance prediction system of FIG. 1 according to an embodiment of the present invention;

FIG. 2B is a flow chat of step 210 in FIG. 2A according to an embodiment of the present invention;

FIG. 2C is a flow chat of step 220 in FIG. 2A according to an embodiment of the present invention;

FIG. 2D is a flow chat of step 230 in FIG. 2A according to an embodiment of the present invention;

FIG. 2E is a flow chat of step 240 in FIG. 2A according to an embodiment of the present invention;

FIG. 3 is a flow chat of an equipment maintenance prediction method applied to the equipment maintenance prediction system of FIG. 1 according to another embodiment of the present invention; and

FIG. 4 is a schematic view illustrating a comparison between a temperature prediction result of a prediction model and the distribution of the actually-sensed temperature sensing values by taking temperature as an example.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

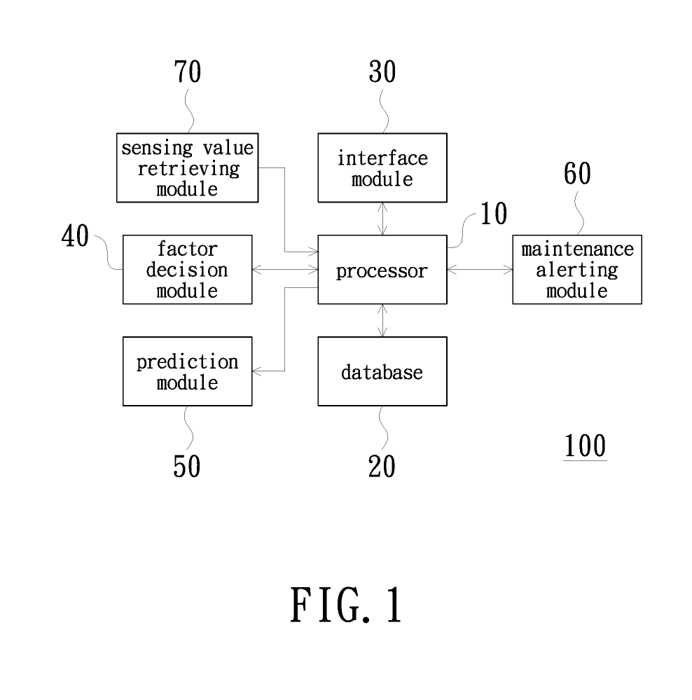

Please refer to FIG. 1. FIG. 1 is a schematic view of an equipment maintenance prediction system according to an embodiment of the present invention. The aforementioned applied equipment may be a frequency converter, and the equipment maintenance prediction system may be a smart phone, a notebook computer or a server host with data receiving and processing capability, but the present invention is not limited thereto. In the present embodiment, the equipment maintenance prediction system 100 includes a processor 10, a database 20, an interface module 30, a factor decision module 40, a prediction module 50 and a maintenance alerting module 60. The processor 10 is electrically connected to the database 20, the interface module 30, the factor decision module 40, the prediction module 50 and the maintenance alerting module 60. The processor 10 is configured to process and forward the received data or signals.

The database 20 is configured to store the data required by the equipment maintenance prediction system 100. The database 20 may be implemented by a memory card or a memory, but the present invention is not limited thereto. In the present embodiment, the database 20 stores a plurality of parameter types corresponding to the applied equipment, wherein the parameter types are various types of data that can reflect the operating status of the equipment. For example, the parameter types are, for example, a running time, a temperature, an output voltage, a current, a speed level and a sensing time of equipment. The database 20 also stores a plurality of historical sensing values of a plurality of parameter types sensed at different times. The historical sensing values can be obtained from the reliability testing on the equipment, other equipment with the same batch number of the equipment, experimental equipment or commercial equipment.

The interface module 30 is configured to display an operation interface, through which the system user can input commands. The interface module 30 outputs selection information to the electrically-connected processor 10 according to the input command. The selection information includes information of a key parameter type and a plurality of parameter types. For example, the system user can select one of a plurality of parameter types displayed by the interface module 30 as the key parameter type and select at least one another parameter type for the subsequent operations. The system user can also select the time interval of the historical sensing values of the key parameter type and the at least one parameter type, for example, select the historical sensing values in the past two years. The interface module 30 may be a touch panel or an input interface group having a mouse, a keyboard and a display panel, but the present invention is not limited thereto.

The factor decision module 40 is configured to operate according to the control of the processor 10. According to the above selection information, the processor 10 configures the factor decision module 40 to select one of the aforementioned at least one parameter type as a decision parameter type based on the key parameter type, wherein the decision parameter type and the key parameter type are the most correlative. Further, in the present embodiment, the factor decision module 40 reads, according to the control of the processor 10, the historical sensing values of the key parameter type and the historical sensing values of the at least one parameter type stored in the database 20. The factor decision module 40 computes the historical sensing values of the key parameter type and the historical sensing values of the at least one parameter type by a stepwise regression method to generate a correlation parameter value (e.g., R squared). The factor decision module 30 selects the parameter type with the largest correlation parameter value as the decision parameter type. In other embodiments, the factor decision module 30 may select a plurality of parameter types with different correlation parameter values as the decision parameter type according to requirements. For example, the parameter types with the largest correlation parameter value and the second largest correlation parameter value may be both selected as the decision parameter type at the same time, but the present invention is not limited thereto.

The prediction module 50 is configured to operate according to the control of the processor 10. When the factor decision module 40 determines the decision parameter type, the processor 10 configures the prediction module 50 to generate a prediction model according to the historical sensing values of the decision parameter type and formulate a maintenance alerting condition according to the historical sensing values of the key parameter type. Further, the prediction module 50 is configured to determine a part of the historical sensing values of the decision parameter type selected by the system user as the first historical sensing value group and determine another part of the historical sensing values as the second historical sensing value group. The prediction module 50 analyzes the time series characteristic of the first historical sensing value group in a time series model and configures the time series model to calculate the first prediction model corresponding to the decision parameter type and the key parameter type according to the time series characteristic of the first historical sensing value group. The first prediction model is configured to predict the prediction sensing values of the key parameter type by the decision parameter type within a time interval. The prediction module 50 introduces the second historical sensing value group into the first prediction model for verification to generate a plurality of verification values. The time series model may be an autoregressive moving average (ARMA) model, an autoregressive integrated moving average (ARIMA) model, an exponential smoothing method or a moving average method, but the present invention is not limited thereto. In other embodiments, the prediction module 50 may perform the verification of time series type on the first historical sensing value group and the second historical sensing value group by using an autocorrelation function (ACF) or a partial autocorrelation function (PACF), and then generate the first prediction model and the second prediction model by using the autoregressive moving average model, but the present invention is not limited thereto.

The prediction module 50 compares a plurality of verification values with the historical sensing values of the key parameter type to determine whether they are consistent. The historical sensing values of the key parameter type correspond to the second historical sensing value of the decision parameter type, for example, the historical sensing values of the key parameter type (temperature) and the historical sensing values of the decision parameter type (voltage) generated at the same time point. The prediction module 50 determines whether the accuracy of the verification values is greater than or equal to an accuracy threshold. The accuracy threshold is 90% for example, but the present invention is not limited thereto. When the accuracy is greater than or equal to the accuracy threshold, the prediction module 50 determines the first prediction model as the prediction model for the equipment maintenance prediction system 100 to predict; otherwise, the prediction module 50 selects another time series model and repeats the above process until the accuracy of the verification values is greater than or equal to the accuracy threshold. When the prediction model is determined, the prediction model is stored in the database 20. The prediction module 50 formulates a maintenance alerting condition according to the prediction model and the distribution of the sensing values within a specific time interval of the historical sensing values of the key parameter type. The maintenance alerting condition may a condition that the number of changes of the sensing values within a specific length of time is greater than a number threshold, but the invention is not limited thereto. The prediction module 50 stores the maintenance alerting condition in the database 20. Taking the key parameter type as temperature as an example. According to the historical sensing values of the key parameter type, it may be indicated that the equipment may fail when the event of the temperature of the equipment is higher than 45° C. have been occurred three times. Therefore, the prediction module 50 may determine the maintenance alerting condition according to the trend of the distribution of the prediction sensing values of the prediction model. For example, when the distribution of the prediction sensing values of the prediction model indicates that the three prediction sensing values having a temperature higher than 45° C. in two hours, the prediction module 50 may refer to the distribution of the historical sensing values of the key parameter type and the distribution of the prediction sensing values of the prediction model to determine the following maintenance alerting condition, in which an alerting is performed when the distribution of real-time sensing values indicates that there are three sensing values having the temperature higher than 45° C. in two hours.

The maintenance alerting module 60 is configured to operate according to the control of the processor 10. When the prediction module 50 determines the maintenance alerting condition, the processor 10 configures the maintenance alerting module 60 to monitor and alert according to the above maintenance alerting condition and a plurality of sensing values generated in real time when the equipment is operating, wherein the sensing values include the temperature, output voltage, current and speed level, but the present invention is not limited thereto. In some embodiments, the maintenance alerting module 60 transmits the maintenance alerting condition to the operation system of the equipment for monitoring, and the maintenance alerting module 60 alerts according to the monitoring result. Further, when the distribution of the real-time sensing values satisfies the maintenance alerting condition, the maintenance alerting module 60 will perform an alert, such as configuring the interface module 30 to display a prompt message. The system user may input the maintenance information via the interface module 30 after completing the maintenance in response to the prompt message or initiatively, wherein the maintenance information is, for example, the maintenance item and the maintenance time. The maintenance alerting module 50 is further configured to store the maintenance information in the database 20.

In some embodiments, the equipment maintenance prediction system 100 may further include a sensing value retrieving module 70. The sensing value retrieving module 70 is electrically connected to the processor 10 and the applied equipment. The sensing value retrieving module 70 is configured to receive a plurality of sensing values transmitted by the equipment in a wired or wireless electrical connection manner and store the received sensing values in the database 20 by the processor 10.

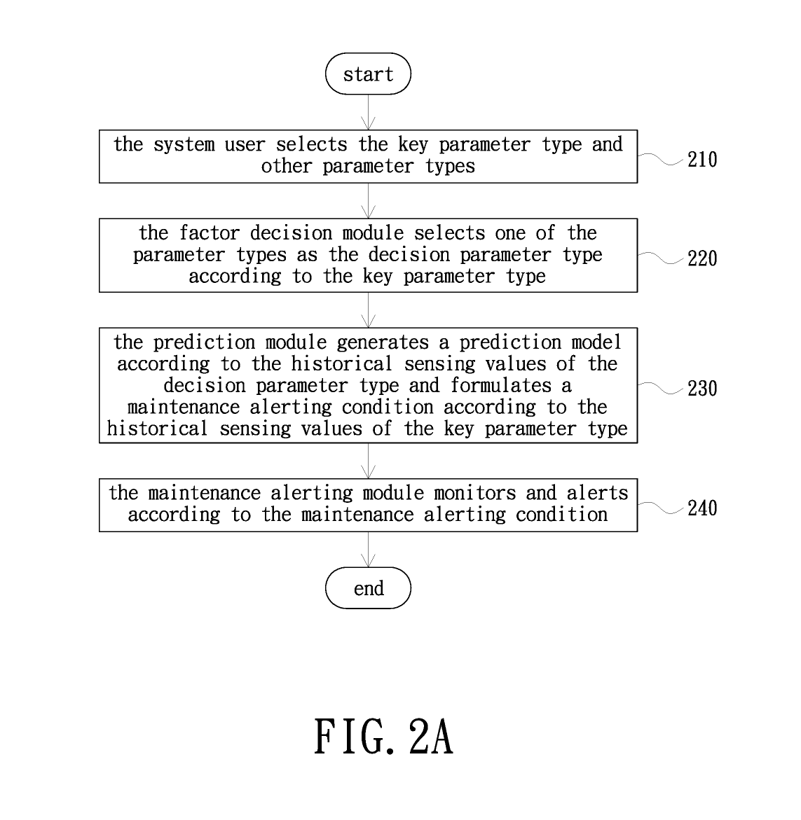

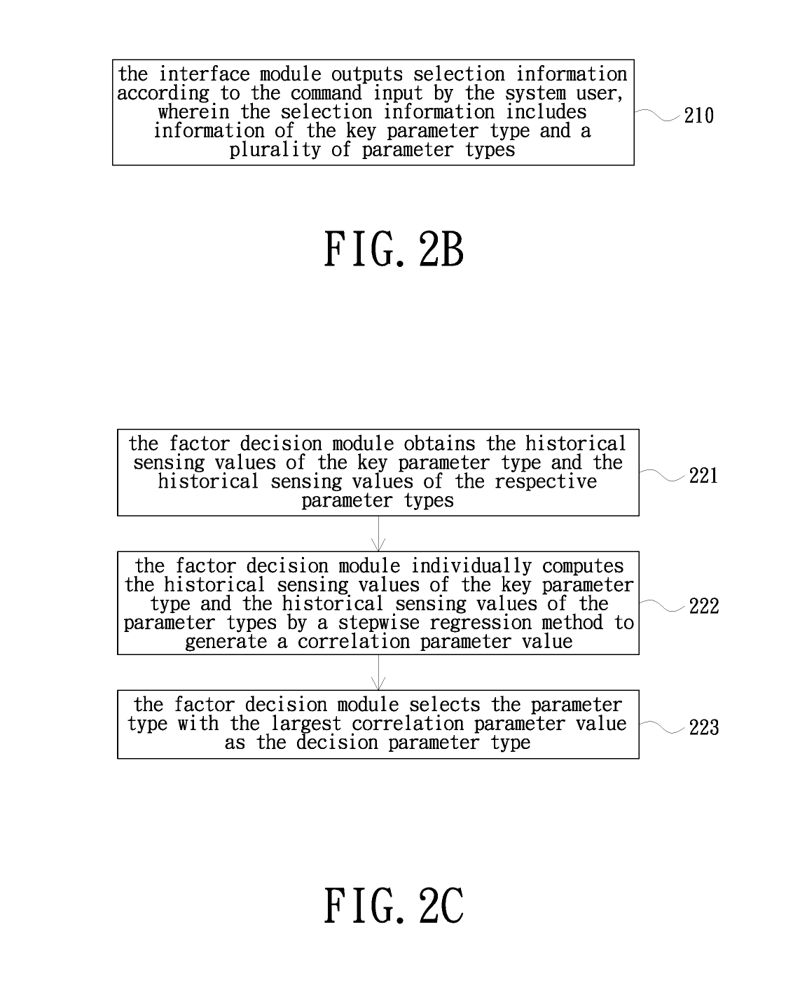

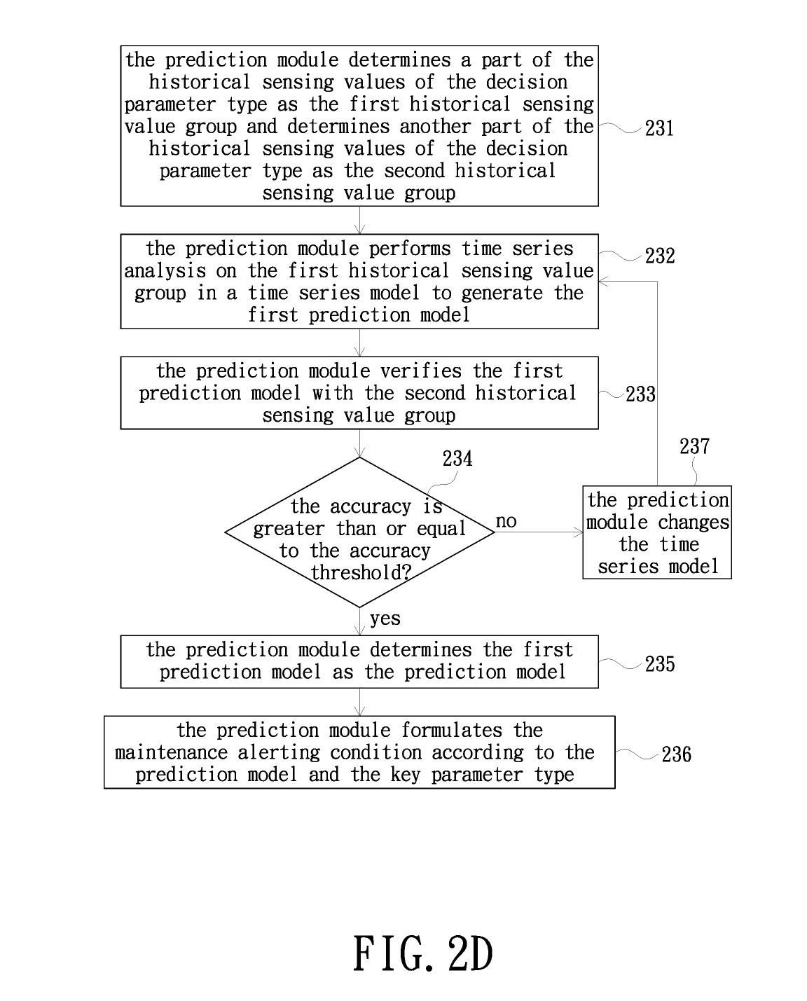

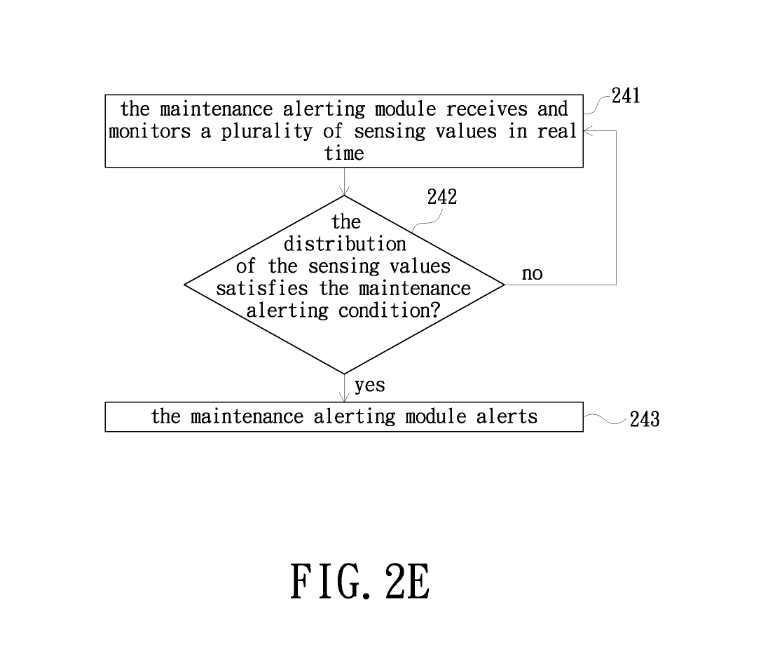

Referring to FIG. 2A. FIG. 2A is a flow chat of an equipment maintenance prediction method applied to the equipment maintenance prediction system described above according to an embodiment of the present invention. In step 210, the system user selects the key parameter type and a plurality of other parameter types via the interface module 30. In step 220, the factor decision module 40 selects one of the parameter types as the decision parameter type according to the key parameter type, wherein the decision parameter type and the key parameter type are the most correlative. In step 230, the prediction module 50 generates a prediction model according to a part of the historical sensing values of the decision parameter type and formulates a maintenance alerting condition according to a part of the historical sensing values of the key parameter type and the prediction model. In step 240, the maintenance alerting module 60 monitors and alerts according to the maintenance alerting condition.

Referring to FIG. 2B. Step 210 further includes that the interface module 30 outputs selection information according to the command input by the system user. The selection information includes information of the key parameter type and a plurality of parameter types. The system user can also select the time interval of the historical sensing values of the key parameter type and the at least one parameter type. Referring to FIG. 2C, step 220 further includes the following steps. In step 221, the processor 10 configures, according to the selection information and the time interval selected by the system user in step 210, the factor decision module 40 to obtain the historical sensing values of the key parameter type and the historical sensing values of the respective parameter types. In step 222, the factor decision module 40 individually computes the historical sensing values of the key parameter type and the historical sensing values of the parameter types by a stepwise regression method to generate a correlation parameter value. Taking the key parameter type as temperature and the parameter type as output voltage and current as an example. The factor decision module 40 computes the historical sensing values of the temperature and the output voltage by a stepwise regression method to generate a correlation parameter value and computes the historical sensing values of the temperature and the current by a stepwise regression method to generate another correlation parameter value. In step 223, the factor decision module 30 selects the parameter type with the largest correlation parameter value as the decision parameter type. In the above example, if the correlation parameter value obtained by temperature and current is 0.5082 and the correlation parameter value obtained by temperature and output voltage is 0.4657, the factor decision module 40 selects the parameter type of current as the decision parameter type. In other embodiments, both of the current and the output voltage may be selected as the decision parameter type according to requirements, but the present invention is not limited thereto.

Referring to FIG. 2D, step 230 further includes the following steps. In step 231, the prediction module 50 determines a part of the historical sensing values of the decision parameter type as the first historical sensing value group and determines another part of the historical sensing values of the decision parameter type as the second historical sensing value group. For example, in step 210, the system user selects a time interval of one year. In step 231, the part of the historical sensing values generated in the first seven months may be determined as the first historical sensing value group and the part of the historical sensing values generated in the last three months may be determined as the second historical sensing value group. In step 232, the prediction module 50 performs time series analysis on the first historical sensing value group in a time series model and calculates the first prediction model according to the analyzing result. In step 233, the prediction module 50 verifies the first prediction model with the second historical sensing value group and calculates the accuracy of the verification result. For example, the second historical sensing value group of the decision parameter type is introduced into the first prediction model for calculation to obtain a plurality of corresponding verification values, and the verification values are compared with the historical sensing values of the key parameter types to determine whether they are consistent, wherein the historical sensing values of the key parameter type correspond to the second historical sensing value of the decision parameter type. In step 234, the prediction module 50 determines whether the accuracy is greater than or equal to the accuracy threshold. If the determination in step 234 is true, step 235 is performed in which the prediction module 50 determines the first prediction model as the prediction model. In step 236, the prediction module 50 formulates the above maintenance alerting condition according to the prediction model and the distribution of the sensing values of a part of the historical sensing values of the key parameter type within the specific time interval. If the determination in step 234 is false, step 237 is performed in which the prediction module 50 changes the time series model and performs step 232.

Referring to FIG. 2E, step 240 further includes the following steps. In step 241, the maintenance alerting module 60 receives and monitors a plurality of sensing values in real time. In step 242, the maintenance alerting module 60 determines whether the distribution of the sensing values satisfies the maintenance alerting condition. If the determination in step 242 is true, step 243 is performed in which the maintenance alerting module 60 alerts. If the determination in step 242 is false, step 241 is performed again.

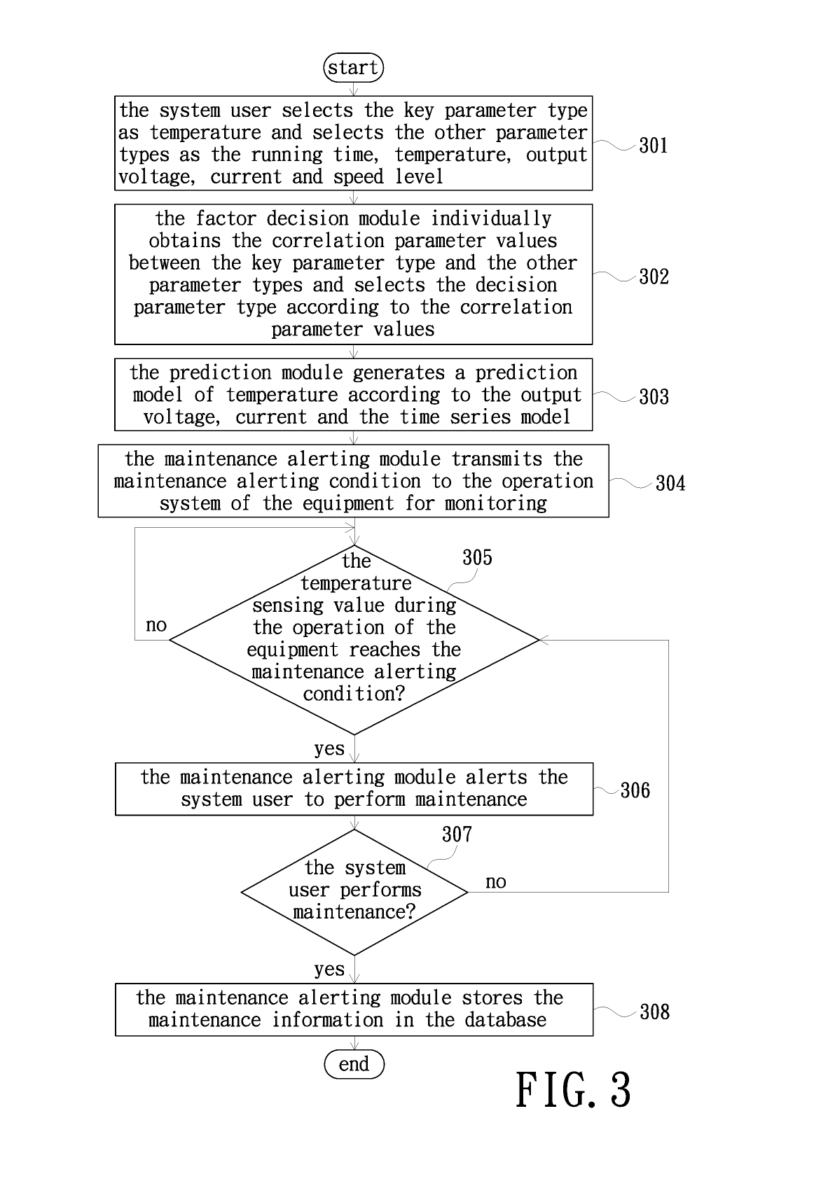

FIG. 3 is a flow chat of an equipment maintenance prediction method applied to the equipment maintenance prediction system described above according to another embodiment of the present invention. First, in step 301, the system user first selects the key parameter type as temperature via the interface module 30 and selects the other parameter types as the running time, temperature, output voltage, current and speed level, and the historical sensing values within two years are selected for the following operation. In step 302, the factor decision module 40 individually obtains the correlation parameter values between the key parameter type and the other parameter types. In the present embodiment, since the correlation parameter value between the temperature and the output voltage and the correlation parameter value between the temperature and the current are relatively large, the output voltage and the current are selected as the decision parameter type. In step 303, the prediction module 50 performs the above step 230 according to the output voltage and the current and selects an optimal time series model to generate the prediction model. The prediction module 50 determines, according to the distribution of the prediction sensing values of the prediction model and the distribution of the historical sensing values of temperature, a maintenance alerting condition in which an alerting is performed when the event that the temperature of the equipment rises from 43° C. to 48° C. have occurred five times within two hours. In step 304, the maintenance alerting module 60 transmits the maintenance alerting condition to the operation system of the equipment for monitoring. In step 305, it is determined whether the temperature sensing value during the operation of the equipment reaches the maintenance alerting condition. If the determination in step 305 is true, step 306 is performed in which the maintenance alerting module 60 configures the interface module 30 to display a prompt message to alert the system user to perform maintenance. If the determination in step 305 is false, step 305 is performed continuously. In step 307, it is determined whether the system user performs maintenance. If the determination in step 307 is true, step 308 is performed in which the system user inputs the maintenance information via the interface module 30 and the maintenance alerting module 60 stores the maintenance information in the database 20, and then step 305 is performed in which the operating status of the equipment is monitored continuously. If the determination in step 307 is false, step 305 is performed.

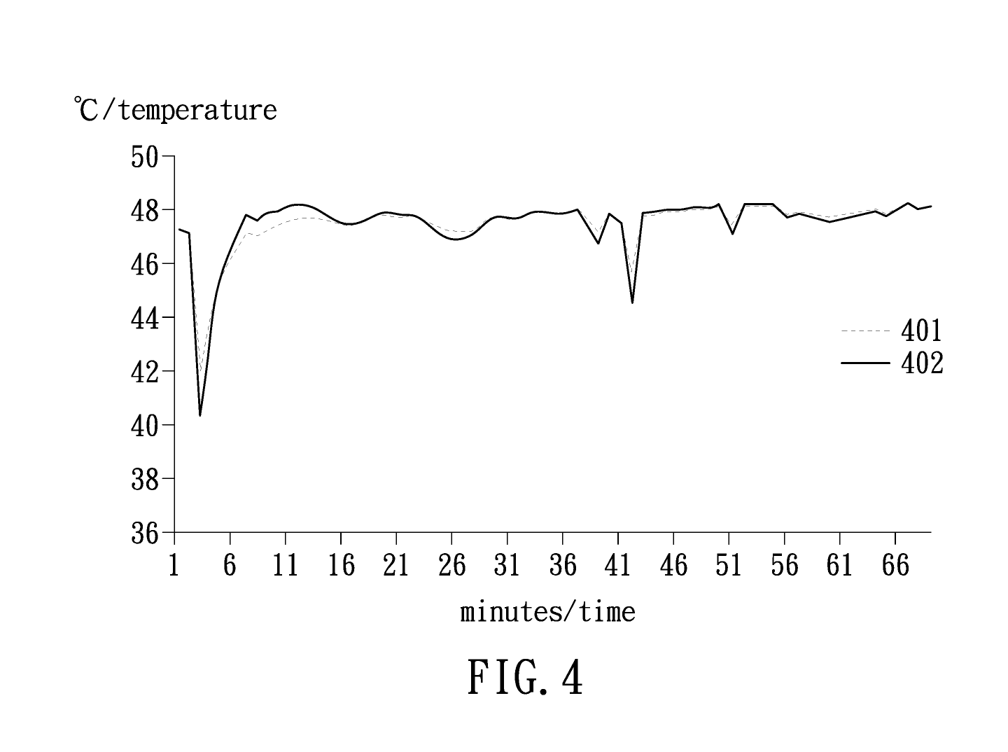

Referring to FIG. 4. FIG. 4 is a schematic view illustrating a comparison between a temperature prediction result of a prediction model and the distribution of the actually-sensed temperature sensing values by taking temperature as an example, wherein the temperature prediction result is curve 401, the temperature sensing value is curve 402, the horizontal axis in FIG. 4 is in minutes and the vertical axis in FIG. 4 is in degrees Celsius (° C.). As shown in FIG. 4, the temperature prediction result is very close to the temperature sensing value, and accordingly it is shown that the equipment maintenance prediction system and the operation method thereof provided by the present invention can accurately predict the required sensing values.

In summary, according to the equipment maintenance prediction system and the equipment maintenance prediction method applied to the equipment maintenance prediction system of the present invention, since the decision parameter type having a better correlation with the key parameter type is first selected, the prediction can be performed by the parameter types other than the key parameter type in the case of without additional sensing elements. In addition, compared to the prediction method employing a single key parameter type, the present invention can improve the accuracy of prediction of equipment life more effectively by establishing the prediction model based on the decision parameter type with relatively high correlation. Further, the sensing values and maintenance information generated during the operation of the equipment are continuously recorded in the database, therefore, with the increase of historical sensing values and reference information, each updated prediction model can predict the trend of the sensing values of the key parameter type more effectively and accurately, the system users can perform maintenance more accurately, and he life of the equipment is improved effectively.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An operation method of an equipment maintenance prediction system, the equipment maintenance prediction system applied to an equipment and comprising a processor, a factor decision module, a prediction module and a maintenance alerting module, the processor being electrically connected to the factor decision module, the prediction module and the maintenance alerting module, and the operation method comprising steps of:
configuring the processor to configure the factor decision module to select one of a plurality of parameter types as a decision parameter type according to a key parameter type, wherein the decision parameter type and the key parameter type are most correlative;
configuring the processor to configure the prediction module to generate a prediction model according to a part of a plurality of historical sensing values of the decision parameter type and formulate a maintenance alerting condition according to a part of a plurality of historical sensing values of the key parameter type; and
configuring the processor to configure the maintenance alerting module to monitor and alert according to the maintenance alerting condition.

2. The operation method according to claim 1, wherein the step of configuring the processor to configure the factor decision module to select one of a plurality of parameter types as a decision parameter type according to a key parameter type and wherein the decision parameter type and the key parameter type are most correlative comprises steps of:
configuring the processor to configure the factor decision module to obtain the part of the historical sensing values of the key parameter type and the part of the historical sensing values of the respective parameter types;
configuring the processor to configure the factor decision module to perform a stepwise regression method on the part of the historical sensing values of the key parameter type and the part of the historical sensing values of the respective parameter types to generate a correlation parameter value; and
configuring the processor to configure the factor decision module to select the parameter type with the largest correlation parameter value as the decision parameter type.

3. The operation method according to claim 1, wherein the step of configuring the processor to configure the prediction module to generate a prediction model according to a part of a plurality of historical sensing values of the decision parameter type and formulate a maintenance alerting condition according to a part of a plurality of historical sensing values of the key parameter type comprises steps of:
configuring the processor to configure the prediction module to determine a part of the historical sensing values of the decision parameter type as a first historical sensing value group and another part of the historical sensing values of the decision parameter type as a second historical sensing value group;
configuring the processor to configure the prediction module to analyze the first historical sensing value group in a time series model to calculate a first prediction model;
configuring the processor to configure the prediction module to introduce the second historical sensing value group into the first prediction model for verification to calculate a plurality of verification values;
configuring the processor to configure the prediction module to determine whether an accuracy of the verification values is greater than or equal to an accuracy threshold;
if yes, configuring the prediction module to determine the first prediction model as the prediction model; and
configuring the processor to configure the prediction module to formulate the maintenance alerting condition according to the prediction model and a distribution of the sensing values within a specific interval of the part of the historical sensing values of the key parameter type.

4. The operation method according to claim 3, wherein the time series model is an autoregressive moving average (ARMA) model, an autoregressive integrated moving average (ARIMA) model, an exponential smoothing method or a moving average method.

5. The operation method according to claim 3, wherein the accuracy threshold is 90%.

6. The operation method according to claim 1, wherein the equipment maintenance prediction system further comprises a database electrically connected to the processor, and the step of configuring the processor to configure the maintenance alerting module to monitor and alert according to the maintenance alerting condition comprises steps of:
configuring the processor to configure the maintenance alerting module to receive and monitor a plurality of sensing values generated when the equipment is operating in real time, wherein the sensing values are the key parameter type and stored in the database;
configuring, when a distribution of the sensing values satisfies the maintenance alerting condition, the maintenance alerting module to perform an alert; and
configuring the maintenance alerting module to store maintenance information in the database.

7. The operation method according to claim 6, wherein the maintenance alerting condition is that a number of changes of the sensing value within a specific length of time is greater than a number threshold.

8. The operation method according to claim 1, wherein the key parameter type and the parameter type are a running time, a temperature, an output voltage, a current and a speed level of the equipment.

9. The operation method according to claim 1, wherein the equipment is a frequency converter.

10. The operation method according to claim 6, wherein the maintenance information comprises a maintenance item and a maintenance time.

11. The operation method according to claim 1, wherein the equipment maintenance prediction system is a smart phone, a notebook computer or a server host.

12. An equipment maintenance prediction system applied to an equipment, the equipment maintenance prediction system comprising:
a processor;
an interface module, electrically connected to the processor and configured to output selection information, wherein the selection information comprises a key parameter type and a plurality of parameter types;
a factor decision module, electrically connected to the processor and configured to select one of the parameter types as a decision parameter type according to the key parameter type, wherein the decision parameter type and the key parameter type are most correlative;
a prediction module, electrically connected to the processor and configured to generate a prediction model according to a part of a plurality of historical sensing values of the decision parameter type and formulate a maintenance alerting condition according to a part of a plurality of historical sensing values of the key parameter type;
a maintenance alerting module, electrically connected to the processor and configured to monitor and alert according to the maintenance alerting condition and a plurality of sensing values generated when the equipment operates; and
a database, electrically connected to the processor and configured to store the historical sensing values of the decision parameter type, the historical sensing values of the key parameter type, the prediction model, the maintenance alerting condition and the sensing values.

13. The equipment maintenance prediction system according to claim 12, further comprising a sensing value retrieving module electrically connected to the equipment and the processor, wherein the sensing value retrieving module is configured to receive the sensing values transmitted by the equipment and transmit the received sensing values to the processor.

14. The equipment maintenance prediction system according to claim 12, wherein the factor decision module performs a stepwise regression method on the part of the historical sensing values of the key parameter type and the part of the historical sensing values of the respective parameter types to generate a correlation parameter value, and the factor decision module selects the parameter type with the largest correlation parameter value as the decision parameter type.

15. The equipment maintenance prediction system according to claim 12, wherein the prediction module determines a part of the historical sensing values of the decision parameter type as a first historical sensing value group and another part of the historical sensing values of the decision parameter type as a second historical sensing value group, the prediction module analyzes the first historical sensing value group in a time series model to calculate a first prediction model, the prediction module introduces the second historical sensing value group into the first prediction model for verification to calculate a plurality of verification values, the prediction module determines the first prediction model as the prediction model when it is determined that an accuracy of the verification values is greater than or equal to an accuracy threshold, and the prediction module formulates the maintenance alerting condition according to the prediction model and a distribution of the sensing values within a specific interval of the part of the historical sensing values of the key parameter type.

16. The equipment maintenance prediction system according to claim 15, wherein the time series model is an autoregressive moving average (ARMA) model, an autoregressive integrated moving average (ARIMA) model, an exponential smoothing method or a moving average method.

17. The equipment maintenance prediction system according to claim 15, wherein the accuracy threshold is 90%.

18. The equipment maintenance prediction system according to claim 12, wherein the maintenance alerting condition is that a number of changes of the sensing value within a specific length of time is greater than a number threshold.

19. The equipment maintenance prediction system according to claim 12, the maintenance alerting module performs an alert when a distribution of the sensing values satisfies the maintenance alerting condition, and the maintenance alerting module stores maintenance information in the database.

20. The equipment maintenance prediction system according to claim 12, wherein the key parameter type and the parameter type are a running time, a temperature, an output voltage, a current and a speed level of the equipment.

21. The equipment maintenance prediction system according to claim 12, wherein the equipment is a frequency converter.

22. The equipment maintenance prediction system according to claim 12, wherein the equipment maintenance prediction system is a smart phone, a notebook computer or a server host.

23. The equipment maintenance prediction system according to claim 19, wherein the maintenance information comprises a maintenance item and a maintenance time.
